(19) United States
(12) Patent Application Publication
(10) Pub. No.: US 2023/0356106 A1
(43) Pub. Date: Nov. 9, 2023

(54) APPARATUS FOR INFUSING AND DISPENSING OILS AND METHOD OF USE

(71) Applicant: Levo Oil Infusion, Inc., Denver, CO (US)

(72) Inventors: Christina Spencer Bellman, Miami, FL (US); Grant Bortz, Lakewood, CO (US)

(73) Assignee: Levo Oil Infusion, Inc., Denver, CO (US)

(21) Appl. No.: 17/736,840

(22) Filed: May 4, 2022

(51) Int. Cl. B01D 11/02

(52) U.S. Cl. CPC B01D 11/0207; B01D 11/0219; B01D 11/0288

(57) ABSTRACT

The present invention pertains in general to an apparatus and method for infusing of a solvent with an infusing material. Embodiments of the invention include applying heat and agitation to the solvent while exposing the infusing material to the solvent for a predetermined time. Upon the end of the infusion process, a removable container can be used to dispense the solvent. Touchless temperature measuring and touchless presence sensing surrounding the removable container allow for the removable container to be placed in the dishwasher when desired.

### FIELD OF THE INVENTION

The present invention pertains in general to an apparatus and method for the infusing, agitation, and dispensation of oils in a manner to produce a desired potency of an infusion while remaining below an identified maximum temperature threshold, and increasing the ease of use and cleanability of the apparatus.

### BACKGROUND OF THE INVENTION

Infusing is the process of transferring chemical compounds, nutrients, or flavors from plant-based material into a solvent, such as water, oil, or alcohol, by allowing the plant-based material to remain suspended in a solvent for a predetermined time and at a predetermined temperature. The resultant liquid produced from the infusion process is often called an “infusion.” Infusing commonly connotes the use of plant-based matter that dissolve quickly or release their active ingredients easily into a solvent. Examples of plant-based matter include, but are not limited to, dried herbs, seeds, flowers, cannabis, or berries. Infusing solvents is a conventional practice in many fields including homeopathic medicine, the culinary arts, skincare, aromatherapy, beauty, alternative wellness, and beverage production.

The infusion process is often referred to as “steeping,” a method that involves heating a liquid to a desired temperature, such as its boiling point or below, before or in concert with the introduction of the infusing material. In many cases, the infusing material comprises plant-based material. The infusing material soaks in the liquid for a predetermined period of time dependent on the purpose for which the infusion is being prepared, the infusing material, and the desired infusion potency. The length of time for steeping also depends upon ingredients which the infusing material comprises as used in the infusion. Some infusing processes require minutes while others require days or weeks. The infusion is often strained to remove the spent infusing material. The infusion may be consumed immediately or be bottled and stored for future use. Infusions are used in their native state or as an ingredient in a recipe or formula.

Typically, a solvent is exposed to infusing material contained in metal, plastic, or paper steeping device having permeable walls. Such steeping devices are filled with material then placed in the solvent for infusing, wherein the permeable walls allow for the passage of solvent and, thus, exposure to the infusing material. Although well-suited for fluids of low viscosity, this prior art steeping technology does not allow for proper fusion of oil-based solvents. More specifically, oil-based solvents are of higher viscosity and, thus often cannot flow through permeable walls suited for water or water-based solvents. Accordingly, to facilitate infusion, oil-based infusion processes commonly must be performed at increased temperatures to reduce their viscosity. Adding heat is also often desirable as it reduces processing time, but increased heat has drawbacks related to safety concerns associated with increase burn exposure. Furthermore, excess heat can denature or negatively affect the solvent or the infusing material.

As alluded to above, infusing chambers are often associated with a heater element and agitator. Some prior art devices include an agitator which is interconnected to a lid of the infusing chamber, wherein a portion of the agitator extends into the infusing chamber when the lid is closed. An agitator helps accelerate the infusing process, particularly when heat is also applied. The agitation further permits control over the infusing process and improves the infusing process such that it occurs in a more homogeneous manner. In operation, the user adds oil-based solvent and infusing material to the infusing chamber which is then exposed to high temperatures by the heater element. Concurrently, the agitator churns the liquid and infusing material, which helps circulate the infusing material into the oil-based solvent. The agitator may be configured to pulverize material to increase its surface area, which exposes more of the material to the solvent and, thus, increases processes effectivity. After the infusing process is complete, the user removes the lid with the interconnected agitator, which may expose the user to hot liquid as it inevitably drips therefrom.

The agitator helps accelerate and control the infusing process, especially when heat is also applied. In operation, the user adds oil-based solvent and often plant-based material to the infusing chamber which is then exposed to high temperatures by the heater element. Concurrently, the agitator churns the liquid and infusing material, which helps circulate the infusing material into the oil-based solvent.

In view of the process involving the infusion of a solvent, wherein the process often uses solvents such as oils exposed to heat, the safety and cleanup of such processes is a concern to many.

There is an identified need for an infusion apparatus which provides a user the ability to infuse a solvent with an infusion material which provides controllability, consistent end-product, repeatable results, and provide easy clean-up.

### SUMMARY OF THE INVENTION

It is an aspect of certain embodiments of the present invention to provide an infusing apparatus wherein a user can place a solvent and infusing material therein, and wherein the solvent is heated and agitated for a predetermined period of time prior to dispensing.

It is an aspect of certain embodiments of the present invention that the solvent is placed within a removable container such as a pitcher wherein the pitcher is configured to be used as a infusing chamber when infusing a solvent, and used as a dispenser when removed.

It is an aspect of certain embodiments of the present invention to provide an infusion apparatus wherein following the infusing of a solvent and dispensing of the solvent, the removable container is configured to be placed in a dishwasher or fully submerged in water without damaging electronic components.

It is an aspect of certain embodiments to control the heating device of the infusing apparatus wherein the heating device is deactivated when a removable container is removed from a base-plate.

It is an aspect of the present invention to provide temperature sensing functionality to detect the temperature of the solvent during the infusion process. In certain embodiments, the temperature sensing is achieved through a contactless temperature sensor offset from the removable container.

It is an aspect of the present invention to provide an infusing apparatus wherein a removable container configured to carry a solvent can be removed after the infusion process and placed in the dishwasher for easy clean-up. In certain embodiments the removable container contains no electronics, sensors, or wires to prevent damage when placed in a dishwasher for cleaning.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1—An exploded perspective view of certain embodiments of the present invention

FIG. 2—A system view of certain embodiments of the present invention

FIG. 3—An exploded perspective view of certain embodiments of the present invention

FIG. 4A—A side view of certain embodiments of the present invention

FIG. 4B—A section view of certain embodiments of the present invention as shown in FIG. 4A

FIG. 5A—A section view of certain embodiments of the present invention as shown in FIG. 4A

FIG. 5B—A detail view of certain embodiments of the present invention as shown in FIG. 5A

FIG. 6—A front view of certain embodiments of the present invention as shown in FIG. 5A

FIG. 7A—An exploded perspective view of certain embodiments of the present invention

FIG. 7B—A top view of certain embodiments of the present invention comprising a removable container

FIG. 7C—A top view of certain embodiments of the present invention comprising a permeable container

### DETAILED DESCRIPTION OF VARIOUS EMBODIMENTS

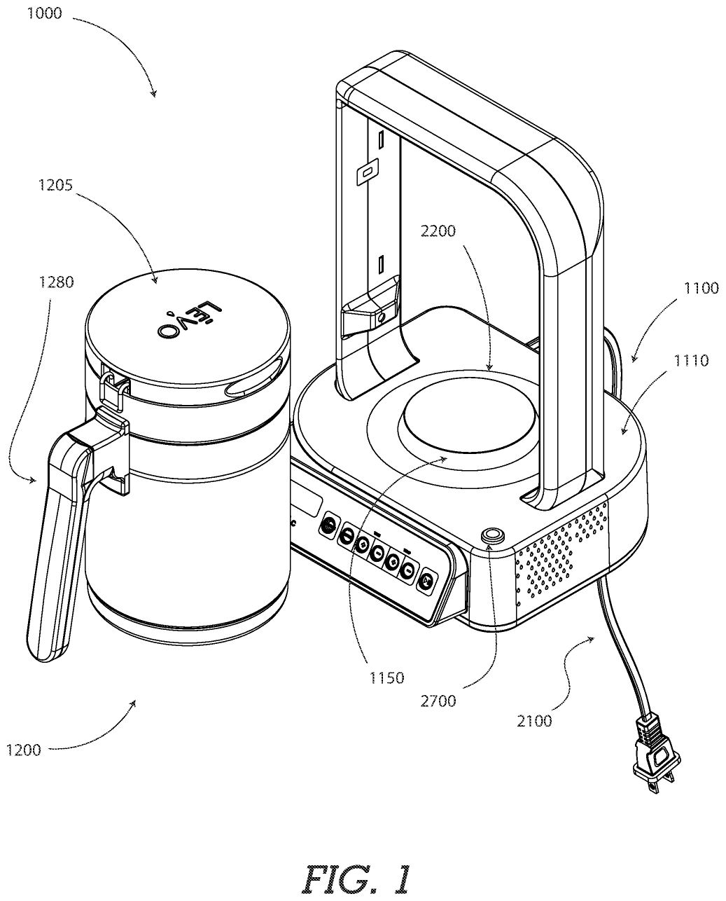

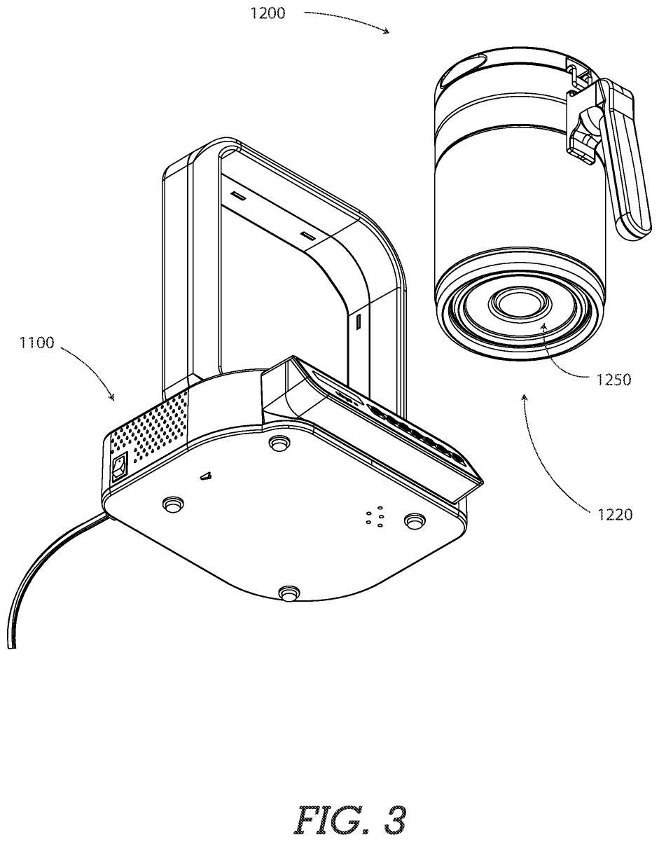

Certain embodiments of the present invention, shown in FIG. 1-FIG. 3 for instance, comprise an apparatus 1000 for the infusion of a solvent. The apparatus comprises a base 1100 having a controller 2000 and a power source 2100. A removable container 1200 comprises a bottom surface configured to be removably interconnected with a top surface 1110 of the base, a lid 1205 and a handle 1280. The top surface 1110 of the base comprises a heat source 2200 interconnected with the power source 2100, wherein the heat source 1150 is configured to heat the removable container 1200 when the removable container is interconnected with the top surface 1110 of the base. Solvents as discussed herein include but are not limited to water, oils, aqueous solutions, or a mixture thereof.

In certain embodiments, the top surface 1110 of the base comprises a protuberance 1150, and the bottom 1220 of the removable container comprises a recess 1250, wherein the recess 1250 is configured to receive the protuberance 1150 therein. The recess 1250 and protuberance 1150 are configured to assure the proper placement of the removable container on the base. Furthermore, the interconnection of the recess 1250 with the protuberance 1150 provides a confirmation to the user that the removable container 1200 is properly located and interconnected with the base 1100. Although embodiments disclosed and shown herein included a base having a protuberance and a removable container comprising a recess configured to receive the protuberance, embodiments with a base comprising a recess configured to receive a protuberance of the removable container, or a base comprising a recess configured to receive a bottom aspect 1220 of the removable container are within the spirit and scope of the present invention.

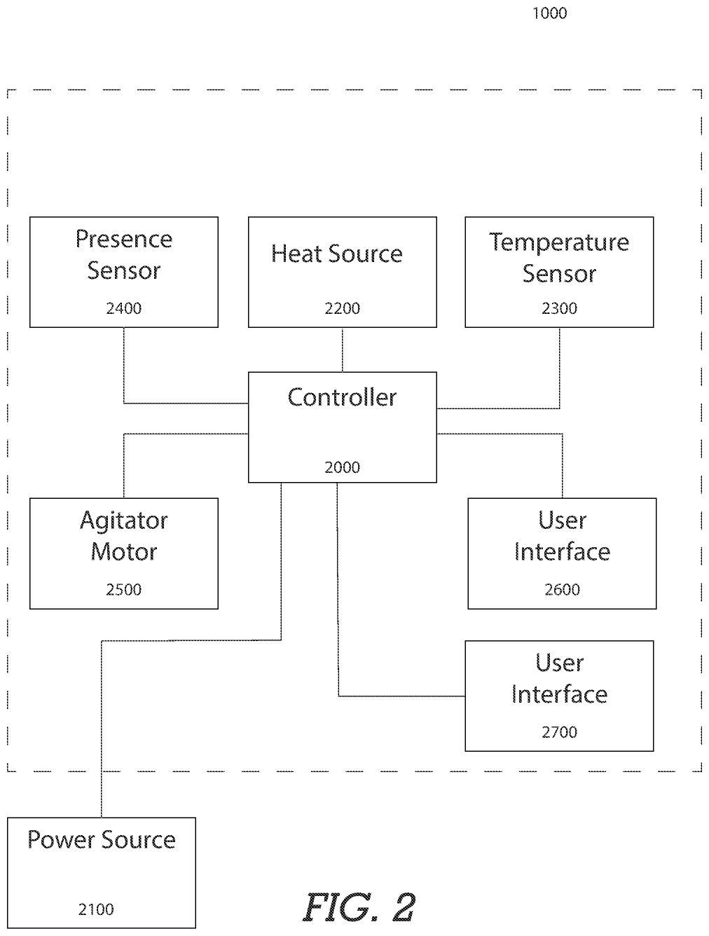

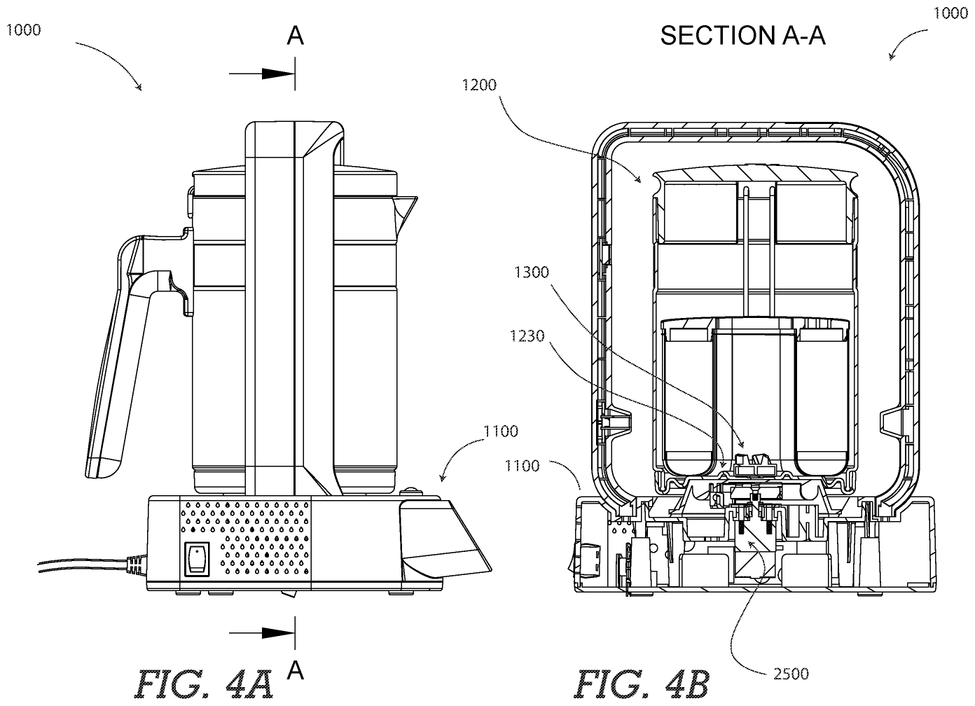

Certain embodiments of the present invention, as shown in FIG. 2 and FIG. 4A-FIG. 4B for instance, a comprise an agitator 1300 interconnected with the internal bottom surface 1230 of the removable container wherein the agitator 1300 is configured to circulate solvent contained within removable container during the infusion process. The agitator 1300 of certain embodiments comprises a magnetic agitator 1300 wherein a motor 2500, interconnected with the base 1100 and having interconnection with the controller 2000 (FIG. 2), is configured to magnetically actuate the agitator 1300 placed within the removable container 1200. The agitator 1300 is configured to be removable to facilitate washing. The agitator motor 2400 which drives the agitator 1300 is interconnected with the controller 2000 wherein the controller controls the speed of the motor 2400 for use during the infusing and agitating processes.

In certain embodiments of the present invention, shown in FIG. 2 and FIG. 4A-FIG. 4B for instance, a temperature sensor 2300 is configured to determine a temperature of the removable container 1200 and communicate the temperature to the controller 2000. In providing the temperature to the controller 2000, the controller 2000 can turn off, turn on, or modulate the power delivery to the heat source 2200 to heat the contents of the removable container to a desired or predetermined temperature. In certain embodiments the temperature sensor 2300 detects the temperature of an external surface 1240 of the removable container 1200. In certain embodiments, the temperature sensor 2300 comprises a touchless temperature sensor 2300 which is offset from the removable container 1200. The touchless temperature sensor of certain embodiments comprises an infrared temperature sensor, while other embodiments comprising alternate touchless temperature sensor technologies are within the spirit and scope of the present invention. “Touchless” as referred to herein refers to a determining a physical trait such as presence, temperature, or other physical trait of an object without direct contact between a sensor and the object—the removable container in this instance.

In certain embodiments, as shown in FIG. 2 and FIG. 4A-FIG. 5A the temperature sensor 2300 is configured to read the temperature of the removable container offset upward from the bottom 1220 of the removable container. The reading of the temperature offset from the bottom 1220 provides increased accuracy in reading the temperature of the removable container 1200 as the operation of the heat source 2200 does not influence the temperature reading as it may at the bottom 1220 of the removable container. Furthermore, reading the temperature offset from the bottom 1220 of the removable container mitigates temperature gradients influenced by the heat source 2200, thermal mass of the base 1100, thermal mass of the bottom 1220 of the removable container, or a natural temperature gradient found within the solvent dependent upon depth.

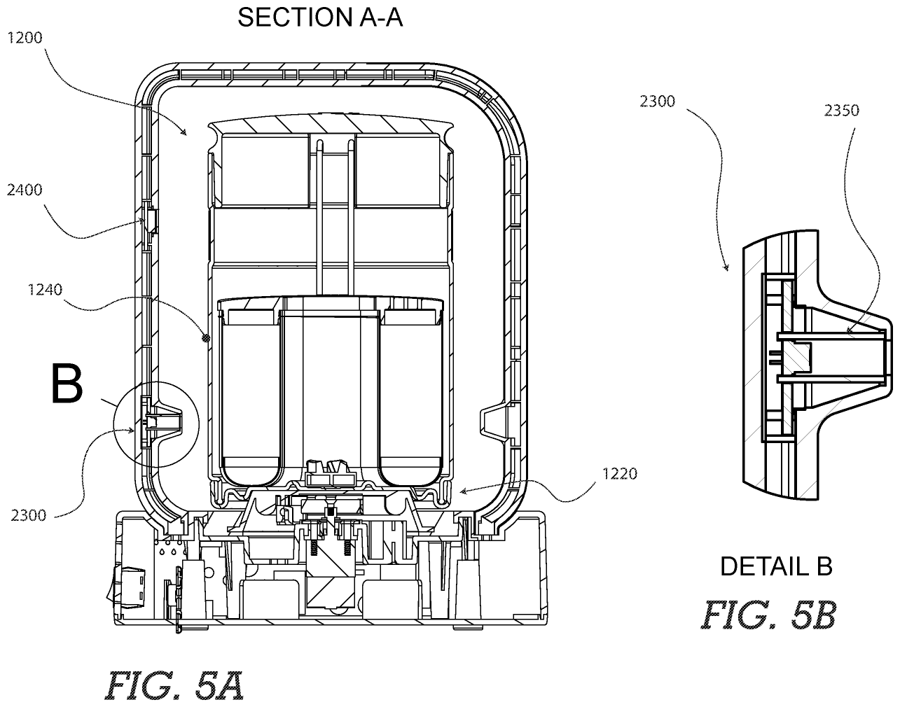

In certain embodiments of an infusing apparatus, as shown in FIG. 2 and FIG. 5A for example, a presence sensor 2400 interconnected with the controller 2000 and communicates the status of the presence of the removable container 1200 to the controller 2000. When the presence of the removable container 1200 is not detected, the controller 2000 sets the heat source 2200 to an off configuration wherein power 2100 to the heat source is cut thereby preventing a fire or burn hazard. When the removable container 1200 is detected, the controller 2000 sets the heat source 2200 to a standby/on configuration wherein the heat source 2200 is provided power in accordance with the desired or predetermined temperature. In certain embodiments the presence sensor 2400 comprises a touchless presence sensor and relies upon light detection to determine the presence of the removable container 1200. In certain embodiments, the presence sensor 2400 comprises a light emitter and a light collector wherein the light emitter shines light toward the removable container 1200 and the light collector is configured to determine the presence of the removable container 1200 based on the amount of light reflected back toward and detected by the light collector. Although touchless presence sensors, and light detecting presence sensors are disclosed herein, alternate embodiments comprising magnetic, weight-based, and electric current sensing presence sensors are within the spirit and scope of the present invention.

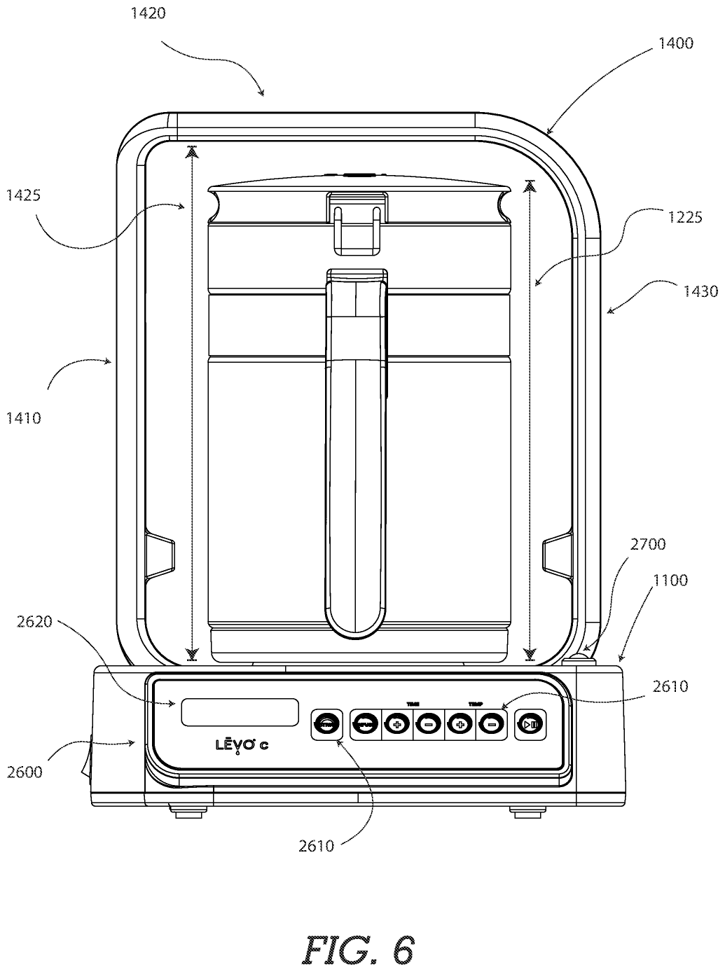

In certain embodiments of an infusing apparatus, shown in FIG. 5A and FIG. 6 for example the base 1100 further comprises a structure 1400 having a first member 1410 extending upward from the base. The structure 1400 is configured to be radially offset from the removable container 1200 when the removable container is interconnected with the base 1100. In certain embodiments the temperature sensor 2300 is interconnected with the structure 1400 wherein the temperature sensor 2300 is configured to read the temperature of the removable container 1200 offset upward from the bottom of the removable container 1220. In certain embodiments the presence sensor 2400 is interconnected with the structure 1400 wherein the presence sensor 2400 is offset upward from the base 1100. In certain embodiments as shown, the presence sensor 2400 is located above the temperature sensor 2300. However, alternate embodiments wherein the temperature sensor is located above the presence sensor, or wherein the temperature sensor and the presence sensor are located at similar heights in relation to each other, are within the spirit and scope of the present invention.

In certain embodiments, such as shown in FIG. 5A-FIG. 5B for example, the temperature sensor 2300 is interconnected with the structure 1400, the temperature sensor 2300 further comprises a sleeve 2350 configured to shield the temperature sensor 2300 from detecting the temperature of other surrounding elements, such as the structure 1400 to which the temperature sensor is interconnected. The sleeve 2350 is configured to be opaque to infrared light and to have a relatively low level of thermal conductivity. For these reasons, in certain embodiments, the sleeve 2350 comprises a steel or stainless-steel composition. However, alternate materials or a combination of materials configured to block infrared radiation and provide a low rate of thermal conductivity are within the spirit and scope of the present invention.

In certain embodiments, shown in FIG. 6 for example, a structure 1400 further comprises a lateral member 1420 extending from the first upright member 1410 and extending in a radially inward direction from the first upright member 1410. The height 1425 of the lateral member is configured to be greater than the height 1225 of the removable container wherein the removable container 1200 is configured to be interconnected with the base 1100 while remaining below the lateral member. In certain embodiments a second upright member 1430 interconnects between the lateral member 1420 and the base 1100 resulting in a hoop structure which is, in certain embodiments, configured to surround the removable container 1200 when the removable container is interconnected with the base.

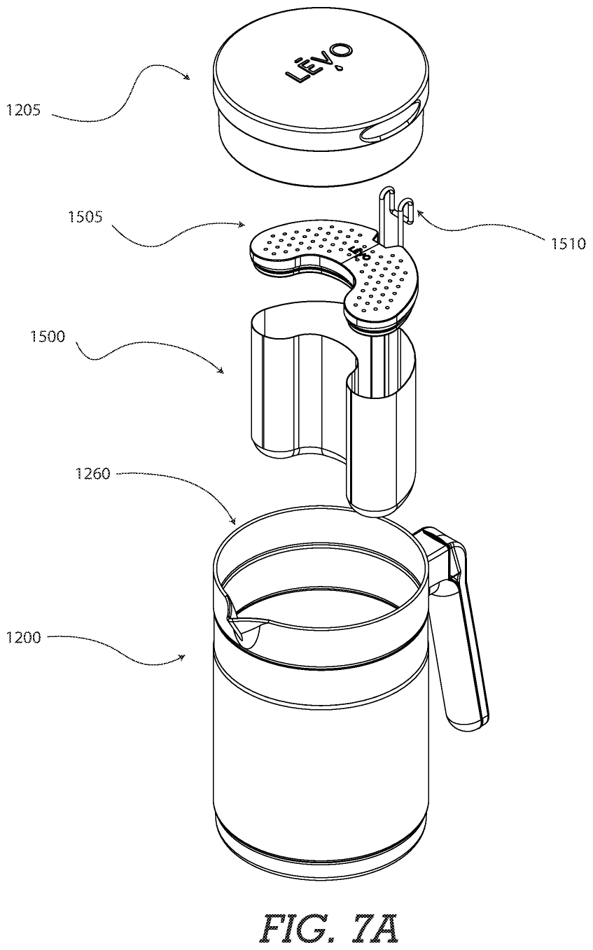

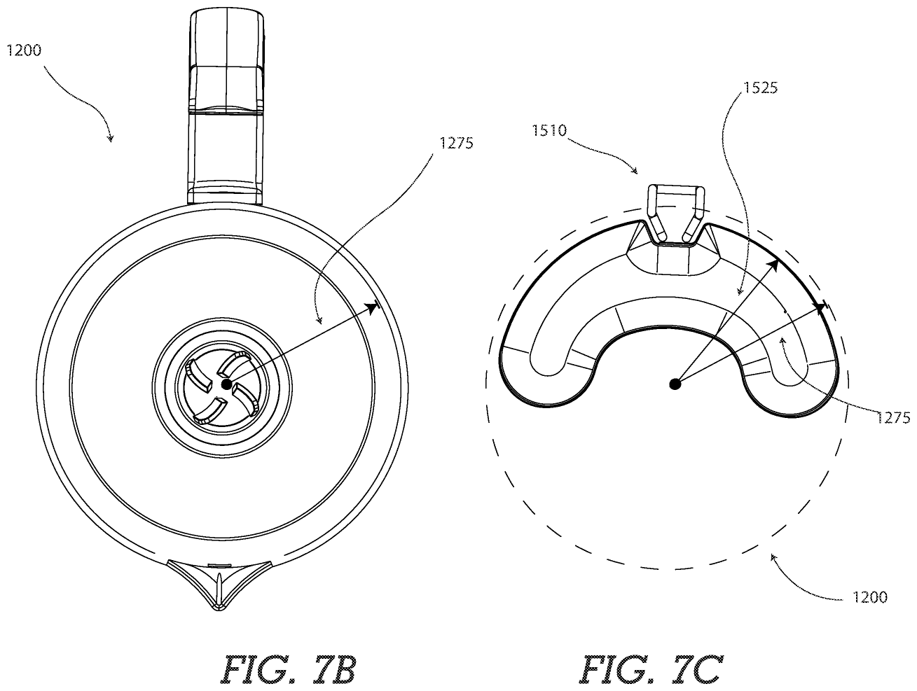

Certain embodiments of the present invention, such as shown in FIG. 7A-FIG. 7C for example, comprise a permeable container 1500 configured to receive infusing material, wherein the permeable container 1500 is configured to be placed within the removable container 1200 for infusing a solvent and be sealed with a lid 1505 prior to placing a lid 1205 on the removable container. In certain embodiments the permeable container 1500 comprises a hook 1510 configured to interconnect with the rim 1260 of the removable container and suspend the permeable container 1500 within the removable container 1200. The permeable container 1500 is removably interconnected to the removable container 1200. In certain embodiments the permeable container 1500 comprises a shape matching or similar to the shape of an internal surface of the removable container. In certain embodiments the permeable container 1500 comprises an arced form wherein the external aspect 1520 of the permeable container is configured to nest with an internal surface 1270 of the removable container. In certain embodiments the arced form of the permeable container comprises a maximum radius 1525 equal to or less than the internal radius 1275 of the removable container. In certain embodiments the permeable container 1500 comprises a semi-circular oblong, or a portion of an annular form. Although embodiments comprising a removable container and permeable container having arced forms having a consistent radius are shown herein, alternate embodiments comprising polygonal shapes, annulus shaped, portions of an annulus shape, complex arced forms, and ovular shaped removable containers and permeable containers are within the spirit and scope of the present invention. The permeable container 1500 of the present invention is configured to nest with the internal surface 1270 of the removable container whereby the permeable container 1500 is exposed to an increased flow of solvent because the maximum flow of a solvent stirred within the removeable container 1200 is proximal to the internal surface 1270 of the removable container. Accordingly, embodiments comprising a permeable container 1500 configured to nest with an internal surface 1270 of the removable container are within the spirit and scope of the present invention.

Certain embodiments of the present invention, shown in FIG. 2 and FIG. 6 for example, comprise a user interface 2600 comprising at least one button 2610, and a display 2620. The 2600 user interface is interconnected with the controller 2000 wherein a user is able to communicate with the controller 2000 to select a predetermined infusing program dependent upon the solvent and the infusion material being used, or program in a custom infusing program with variable including but not limited to temperature, and length of time for infusion.

Certain embodiments comprise a heat indicator light 2700 interconnected with the controller 2000 wherein the 2700 heat indicator light alerts a user to the presence of hot components such as a heated removable container 1200, or heated heat source 2200.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. An apparatus for the infusion of a solvent with an infusing material comprising:
a base;
a controller comprising a power source;
a removable container having a bottom surface configured to removably interconnect with a top surface of the base;
the top surface of the base comprising a heat source connected to the power source, and wherein the heat source is controlled by the controller;
a temperature sensor interconnected with the base, wherein the temperature sensor is configured to detect a temperature of the removable container and communicate the temperature of the removable container to the controller.

2. The apparatus of claim 1, wherein the temperature sensor is offset from the removable container.

3. The apparatus of claim 2, wherein the temperature sensor is configured to read the temperature of the removable container at a height offset from the bottom of the removable container.

4. The apparatus of claim 1, wherein the base further comprises a structure having a first upright member extending upward from the base wherein the structure is configured to be offset from the removable container when the removable container is interconnected with the base.

5. The apparatus of claim 4, wherein the temperature sensor is interconnected with the structure, and wherein the temperatures sensor comprises a touchless temperature sensor.

6. The apparatus of claim 5, wherein the temperature sensor is directed radially inward toward the removable container.

7. The apparatus of claim 6, wherein the temperature sensor further comprises a sleeve wherein the temperature sensor is configured to detect the temperature of the removable container through a bore of the sleeve.

8. The apparatus of claim 7, further comprising a presence sensor, wherein the container presence sensor is interconnected with the controller;
the presence sensor is configured to detect a presence or an absence of the removable container, and communicate the presence or the absence of the removable container to the controller.

9. The apparatus of claim 8, wherein when the presence sensor detects the presence of the removable container, the controller configures the heat source in an on/standby configuration, and
wherein when the presence sensor detects the absence of the removable container, the controller configures the heat source in an off configuration.

10. The apparatus of claim 9, wherein the presence sensor comprises a light emitter and a light collector, wherein the light collector measures the amount of light from the light emitter which is reflected back to determine the presence or the absence of the removable container.

11. The apparatus of claim 9, wherein the presence sensor comprises an infrared light collector.

12. The apparatus of claim 8, further comprising an agitator interconnected with a bottom internal surface of the removable container.

13. The apparatus of claim 12, wherein the agitator comprises a stirring portion and a driving portion, wherein the stirring portion comprises a magnetic material, and the stirring portion comprises a magnet;
the driving portion is interconnected with the

14. The apparatus of claim 1, further comprising a presence sensor, wherein the container presence sensor is interconnected with the controller;
the presence sensor is configured to detect a presence or an absence of the removable container, and communicate the presence or the absence of the removable container to the controller.

15. The apparatus of claim 11, wherein when the presence sensor detects the presence of the removable container, the controller configures the heat source in an on/standby configuration, and
wherein when the presence sensor detects the absence of the removable container, the controller configures the heat source in an off configuration.

16. The apparatus of claim 5 wherein the structure extends upward wherein a height of the structure is greater than a height of the removable container.

17. The apparatus of claim 16 wherein the structure further comprises a lateral member having a first end interconnected with the first upright member wherein the lateral member extends in a radially inward direction;
the lateral member further comprises a height wherein the height of the lateral member is greater than the height of the removable container.

18. The apparatus of claim 17 wherein the structure further comprises a second upright member;
the second upright member is interconnected with the base and extends upward; and
a second end of the lateral member is interconnected with the second upright member,
wherein the removable container is configured to be interconnected with the base wherein the removable container is between the first upright member and the second upright member, and below the lateral member.

19. The apparatus of claim 18, further comprising a permeable container;
the permeable container comprises a hook configured to suspend the permeable container within the removable container from a rim of the removable container.

20. The apparatus of claim 19, wherein the permeable container comprises a portion of an annular form wherein an outer diameter of the permeable container is configured to nest within an inner diameter of the removable container.
